(19) United States
(12) Patent Application Publication
(10) Pub. No.: US 2012/0198696 A1
(43) Pub. Date: Aug. 9, 2012

(54) SOLAR STRING ASSEMBLY PROCESS

(75) Inventors: David S. Potter, Danville, CA (US); Nathan Dion Fleischer, Berkeley, CA (US); Timothy McDonnell Brown, Belmont, CA (US); Jeffrey Paul Munoz, Oakley, CA (US)

(73) Assignee: CHEVRON USA INC., San Ramon, CA (US)

(21) Appl. No.: 13/368,607

(22) Filed: Feb. 8, 2012

Related U.S. Application Data
(60) Provisional application No. 61/440,790, filed on Feb. 8, 2011.

(51) Int. Cl. H01L 31/18; B25B 11/00

(52) U.S. Cl. 29/890.033; 29/281.1

(57) ABSTRACT

The present invention is directed to a process for aligning two solar panel support channels substantially parallel in a substantially planar pre-assembly tool, wherein the pre-assembly tool has two solar panel support channels guides for receiving and aligning the two solar panel support channels substantially parallel to one another; aligning a plurality of solar panels on top of the two solar panel support channels near opposing edges of each solar panel; and attaching the plurality of solar panels to the two solar panel support channels, thereby forming a solar panel string assembly.

### COPYRIGHT NOTICE AND AUTHORIZATION

This patent document contains material which is subject to copyright protection.

© Copyright 2011-2012. Chevron Energy Solutions Company, a division of Chevron U.S.A. Inc. All rights reserved.

With respect to this material which is subject to copyright protection. The owner, Chevron Energy Solutions Company has no objection to the facsimile reproduction by any one of the patent disclosure, as it appears in the Patent and Trademark Office patent files or records of any country, but otherwise reserves all rights whatsoever.

### FIELD OF THE INVENTION

This invention relates an apparatus and method for pre-assembly of certain components of a solar canopy.

### BACKGROUND OF THE INVENTION

Solar energy is a clean, renewal energy source. Photo-electro voltaic cell technology is increasing rapidly and makes installation of solar collector panels housing the photo-electro voltaic cells more and more economically feasible. Beyond the photo-electro voltaic cell technology itself are the problems of placement and support of the solar collector panels. Large numbers of solar collector panels must be assembled in series to achieve useful power production. In remote areas these may be placed on the ground without interfering with land use. In more developed areas, it is desirable to place the solar collector panels such that the land may also be used for other purposes, e.g., for parking lots, school/office hallways, playgrounds, or sports fields. To achieve this requires an elevated structure to support the solar collector panels.

In prior known systems, installation costs amount to around 25% of the overall cost of a solar parking shade installation. These installation cost includes the cost to place modules on a rack, wire the modules together and to a combiner box, bolt the modules in place, and place the support structure on a parking shade structure. These costs often amount to almost the actual panel cost themselves due to the lack of ability to achieve assembly efficiency as well as the need in governmental markets to use union labor.

An additional deficiency in known methods/systems for solar canopy installation is that the size of solar modules used is limited to the size module a contractor can physically carry. The installation process is also cumbersome and dangerous due to work on nonstandard sites and at an elevated height.

It is desirable to have a method and system which overcomes the deficiencies of known systems. The instant invention provides such a solution.

### SUMMARY OF THE INVENTION

The invention in one embodiment includes a process for aligning two solar panel support channels substantially parallel in a substantially planar pre-assembly tool, wherein the pre-assembly tool has two solar panel support channels guides for receiving and aligning the two solar panel support channels substantially parallel to one another; aligning a plurality of solar panels on top of the two solar panel support channels near opposing edges of each solar panel; and attaching the plurality of solar panels to the two solar panel support channels, thereby forming a solar panel string assembly.

The invention in another embodiment includes a machine for pre-assembly of a solar panel string for a solar canopy, the machine a substantially planar base component, sufficiently long to hold a plurality of solar panels; two substantially parallel solar panel support channels guides attached to a top portion of the base component and extending from one end to an opposing end of the base component, each configured and adapted for receiving and aligning a solar panel support channel; a void in a center portion of the base component between the two support channel guides to provide a working space for electrical connections and components at the bottom of the solar panels.

These and other features and advantages of the present invention will be made more apparent through a consideration of the following detailed description of a preferred embodiment of the invention. In the course of this description, frequent reference will be made to the attached drawings.

### BRIEF DESCRIPTION OF THE DRAWINGS

FIG. 1 is a perspective view of one embodiment of the present invention depicting the base component and the 2 solar panel support channel guides.

FIG. 2 is a perspective view of one embodiment of the present invention depicting the base component, the 2 solar panel support channel guides, a support channel placed in each solar panel support channel guides.

FIGS. 3-4 are perspective views of one embodiment of the present invention depicting the addition of a plurality of solar panels being added to the tool depicted in FIG. 2, and showing a frame of the solar panels for rivet holes, and added rivets for attaching the solar panels to the solar panel support channels.

### DETAILED DESCRIPTION OF PREFERRED EMBODIMENTS

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

As used in this specification and claims, the “solar panel support channels” comprise “Z”-shaped sheet metal, i.e., “Zee-channels” or “Z-channels”, “C”-shaped sheet metal, i.e., “Cee-channels” or “c-channels”, or standard beams, bars, and other suitable support members.

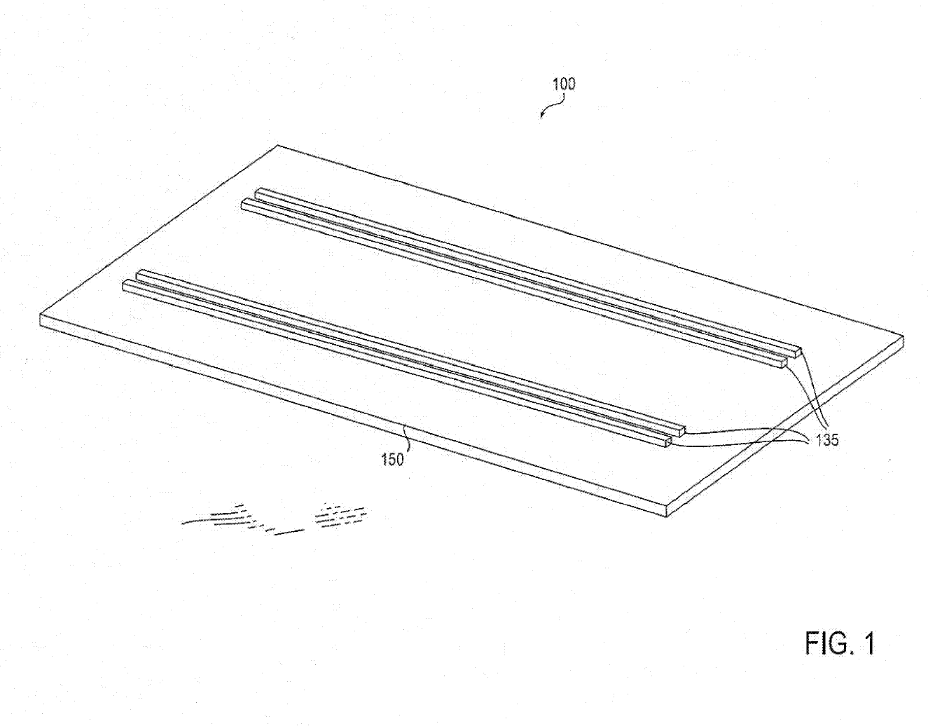

With reference to FIG. 1, a machine 100 for solar panel string assembly is shown with a substantially planar base component 150 and two sets of solar panel support channel guides 135. The machine 100 is ready to begin assembly of a solar panel string assembly.

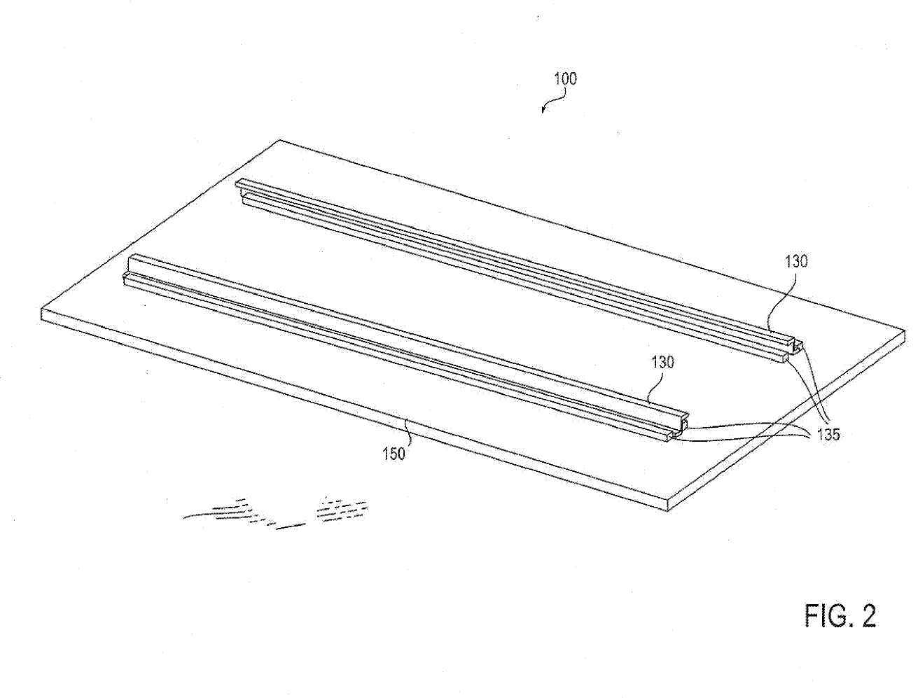

With reference to FIG. 2, two solar panel support channels 130 are positioned in the solar panel support channel guides 135. The positioning is done manually, robotically, or any other known means. The next step is positioning of the solar panels.

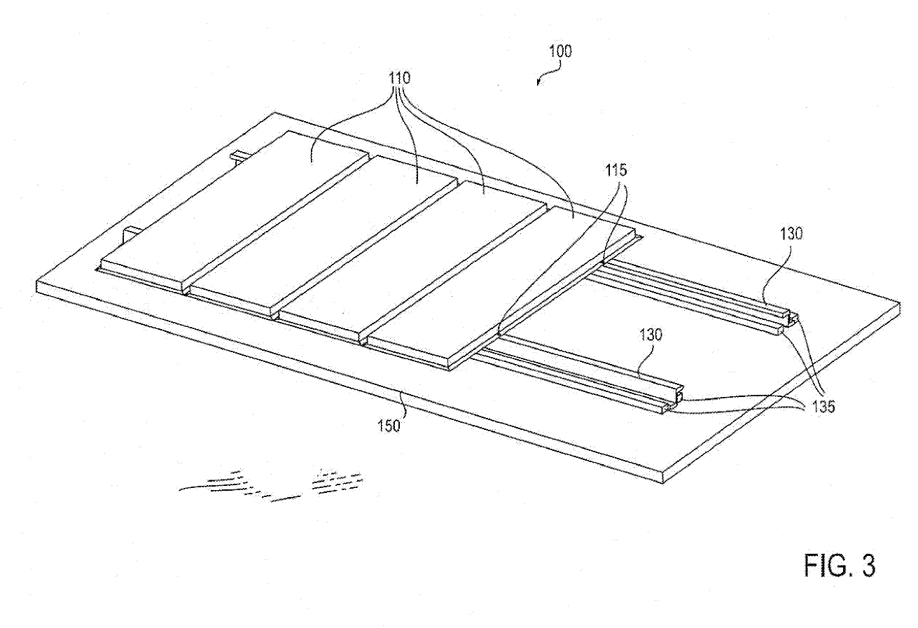

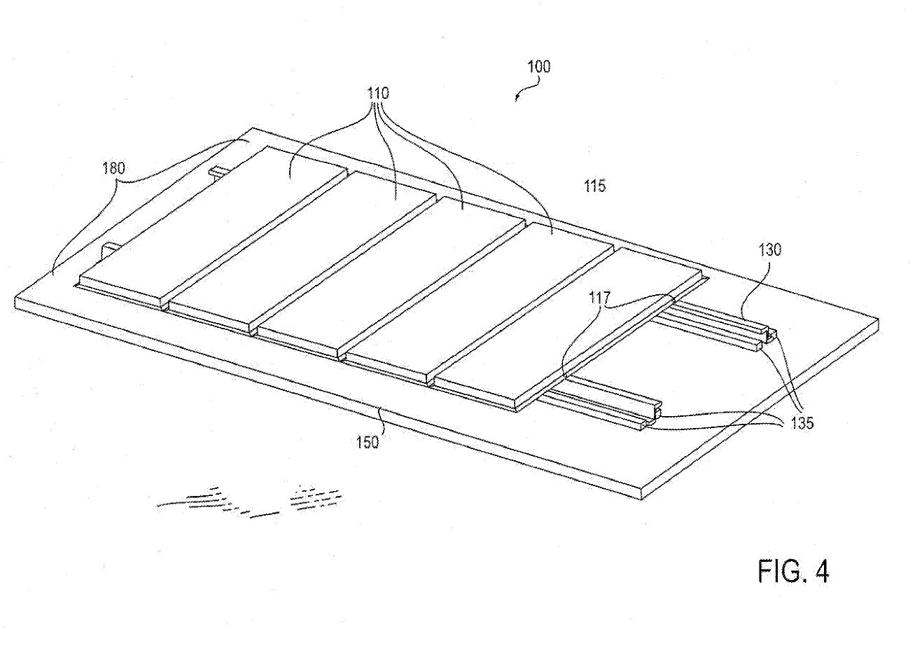

With reference to FIGS. 3-4, a plurality of solar panels 110 are positioned on top of the solar panel support channels 130 for attachment. Solar panels 110 optionally have integral alignment tabs for aligning placement. In one embodiment a frame of the solar panels has rivet holes 115 (FIG. 3) for receiving rivets 117 (FIG. 4) for attachment of the solar panels 110. The solar panels 110 are positioned on top of the solar panel support channels 130. Any other known attachment means may be used such as screw, bolt, or glue. In one embodiment planar base component 150 has a hole or void in its center of sufficient size and placement to allow a worker or machine access beneath for additional assembly work from underneath. This could include, e.g., attachment where attachment is done from the bottom, making electrical connections between the solar panels 110, installation of an electrical inverter or other components. Once the plurality of solar panels 110 are attached to the solar panel support channels 130, then the solar panel string assembly 180 is completed and ready to remove.

What has been described above includes example embodiments of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as that term is interpreted as a transitional word in a claim.

What is claimed is:

1. A process for pre-assembly of a solar panel string for a solar canopy, the process comprising:
(a) aligning two solar panel support channels substantially parallel in a substantially planar pre-assembly tool, wherein the pre-assembly tool has two solar panel support channels guides for receiving and aligning the two solar panel support channels substantially parallel to one another;
(b) aligning a plurality of solar panels on top of the two solar panel support channels near opposing edges of each solar panel; and
(c) attaching the plurality of solar panels to the two solar panel support channels, thereby forming a solar panel string assembly.

2. The process of claim 1 wherein the pre-assembly tool is configured to provide working space beneath it sufficient for making electrical connections and attaching electrical components.

3. The process of claim 2 wherein the pre-assembly tool is configured to provide working space beneath it sufficient for making electrical connections and attaching electrical components by tilting the substantially planar pre-assembly tool.

4. The process of claim 1, wherein the solar panel string assembly lay parallel with the ground surface for loading on a truck for transportation to the job site.

5. The process described in claim 1, further comprising electrically connecting the plurality of solar panels to one another in series.

6. The process described in claim 1, further comprising attaching a direct current to alternating current inverter to the solar panel support channel and electrically connecting the inverter to the plurality of solar panels.

7. The process described in claim 1, wherein the solar panel support channels are “Z”-channels.

8. The process described in claim 1, wherein the solar panel support channels are “C”-channels.

9. The process described in claim 1, wherein the solar panel support channels comprises integral alignment tabs for the solar panels on the solar panel support channels.

10. The process described in claim 1, wherein the plurality of solar panels is from about 4 to about 20 solar panels.

11. The process described in claim 1, further comprising manufacturing the solar panel support channel at a solar canopy construction site using rolled sheet metal form extrusion.

12. The process described in claim 1, further comprising attaching an eye bolt to the solar panel string assembly for lifting the solar panel string assembly during construction.

13. The process described in claim 1, further comprising lifting the solar panel string assembly during construction via suction cups attached to at least on of the solar panels in the solar panel string assembly.

14. The process described in claim 1, wherein the solar panel support channel is attached to the plurality of solar panels via an attachment means selected from gluing, riveting, bolting, welding or mixtures thereof.

15. A machine for pre-assembly of a solar panel string for a solar canopy, the machine comprising:
(a) a substantially planar base component, sufficiently long to hold a plurality of solar panels;
(b) two substantially parallel solar panel support channels guides attached to a top portion of the base component and extending from one end to an opposing end of the base component, each configured and adapted for receiving and aligning a solar panel support channel;
(c) a void in a center portion of the base component between the two support channel guides to provide a working space for electrical connections and components at the bottom of the solar panels.
